(19) United States
(12) Patent Application Publication
(10) Pub. No.: US 2025/0121900 A1
(43) Pub. Date: Apr. 17, 2025

(54) CARGO BICYCLE

(71) Applicant: CARGONE INC., Laval (CA)

(72) Inventors: Sébastien JUTRAS, Laval (CA); Guy DRAPEAU, Montreal (CA); Antoine CÔTÉ, Laval (CA); Félix SAINT-DENIS, Val-D’Or (CA); Érick AUGER, Granby (CA)

(21) Appl. No.: 18/722,407

(22) PCT Filed: Dec. 21, 2022
(86) PCT No.: PCT/CA2022/051879

§ 371 Date: Jun. 20, 2024

Related U.S. Application Data
(60) Provisional application No. 63/292,413, filed on Dec. 21, 2021.

(51) Int. Cl. B62J 9/23; B62J 6/04; B62K 7/04; B62K 21/16

(52) U.S. Cl. CPC B62J 9/23; B62K 7/04; B62K 21/16; B62J 6/04

(57) ABSTRACT

A rear loading device for a bicycle is disclosed with a central structure portion configured to be secured to a bicycle frame rearwardly of its crankset, a left-side structure portion and a right-side structure portion pivotally connected to the central structure portion, and a mechanism including at least one joint connecting the left-side structure portion and the right-side structure portion to the central structure portion or to the frame of the bicycle, the mechanism enabling displacement of the left-side structure portion and the right-side structure portion relative to one another between a deployed configuration in which top ends of the left-side structure portion and the right-side structure portion are distanced to define a cargo volume therebetween, and a retracted configuration in which the top ends of the left-side structure portion and the right-side structure portion are adjacent to one another to reduce the cargo volume.

### CROSS-REFERENCE TO RELATED APPLICATIONS

This application claims priority from U.S. patent application 63/292,413 filed on Dec. 21, 2021, the entire contents of which are incorporated by reference herein.

### TECHNICAL FIELD

The application relates generally to bicycles and, more particularly, to cargo bicycles and related devices to carry merchandise, loads and passengers.

### BACKGROUND OF THE ART

Loading devices such as permanently installed boxes and crates used on some cargo bicycles can offer a big loading capacity but present a lot of compromises due to their closed and fixed configuration. These compromises may include having a big overall volume and weight even when the loading device is not in use and difficulty loading and installing passengers and/or merchandise within the available volume. When expandable panniers or slings are used as loading devices, they can often be limited in cargo weight capacity and volume, fiddly to close and secure at maximum capacity, and may interfere with passenger transport. Furthermore, those kinds of existing loading devices can often result in a wide bicycle that can be problematic in certain circumstances such as transportation/storage and manoeuvring.

Cargo bicycles may not be adapted to be shared amongst different people with different physiologies. Bike adjustments for riders may be time consuming and inefficient. Some riders may choose not to ergonomically adjust the bicycle before use, if not quick and easy, and this may affect safety.

### SUMMARY

It is an aim of the present disclosure to provide a novel cargo bicycle with enhanced overall loading volume, usability and versatility.

In accordance with one aspect, there is provided a rear loading device for a bicycle comprising: a central structure portion configured to be secured to a frame of the bicycle rearwardly of a crankset of the bicycle, a left-side structure portion and a right-side structure portion pivotally connected to the central structure portion, and a mechanism including at least one joint connecting the left-side structure portion and the right-side structure portion to the central structure portion or to the frame of the bicycle, the mechanism enabling displacement of the left-side structure portion and the right-side structure portion relative to one another between a deployed configuration in which top ends of the left-side structure portion and the right-side structure portion are distanced to define a cargo volume therebetween, and a retracted configuration in which the top ends of the left-side structure portion and the right-side structure portion are adjacent to one another to reduce the cargo volume.

Further in accordance with the above aspect, for example, the central structure portion includes side loader links projecting laterally relative to the frame of the bicycle, the left-side structure portion and the right-side structure portion being pivotally connected to the side loader links.

Further in accordance with the above aspects, for example, the central structure portion surrounds a rear wheel of the bicycle, whereby a top portion of the central structure portion is configured to receive seating.

Further in accordance with the above aspects, for example, the mechanism includes a left-side linear joint between the left-side structure portion and the central structure portion, and a right-side linear joint between the right-side structure portion and the central structure portion, an expansion of the left-side linear joint and of the right-side linear joint causing the displacement toward the deployed configuration.

Further in accordance with the above aspects, for example, the left-side linear joint and the right-side linear joint are pivotally connected at opposed ends to the central structure portion, and to the left-side structure portion and to the right-side structure portion, respectively.

Further in accordance with the above aspects, for example, the left-side linear joint and the right-side linear joint are telescopic joints.

Further in accordance with the above aspects, for example, the telescopic joints are telescopic cylinders having lockable positions.

Further in accordance with the above aspects, for example, the telescopic cylinders are manually lockable to the lockable positions.

Further in accordance with the above aspects, for example, the left-side linear joint and the right-side linear joint are releasably connected to the central structure portion.

Further in accordance with the above aspects, for example, the mechanism includes a single translational joint.

Further in accordance with the above aspects, for example, the single translation joint is a bracket configured to slide along an upstanding frame member, with a left-side strut pivotally connected to the bracket and to the left-side structure portion, and with a right-side strut pivotally connected to the bracket and to the right-side structure portion.

Further in accordance with the above aspects, for example, the upstanding frame member is a seat tube of the frame of the bicycle.

Further in accordance with the above aspects, for example, a blocking handle is manipulable to lock the bracket along the upstanding frame member.

Further in accordance with the above aspects, for example, the left-side structure portion and the right-side structure portion are releasably connected to the central structure portion.

Further in accordance with the above aspects, for example, the left-side structure portion and the right-side structure portion include inverted U-shaped structures pivotally connected at the free ends to the central structure portion.

Further in accordance with the above aspects, for example, panels cover the U-shaped structures.

Further in accordance with the above aspects, for example, at least one rear panel extends from a rear portion of the left-side structure portion and the right-side structure portion.

Further in accordance with the above aspects, for example, the at least one rear panel has a closeable access.

Further in accordance with the above aspects, for example, at least part of the central structure portion is permanently connected to the frame of the bicycle.

In accordance with another aspect, there is provided a bicycle comprising: a frame; and the rear loading device in accordance with any one of the previous aspects, the rear-loading device being mounted to the frame.

### DESCRIPTION OF THE DRAWINGS

Reference is now made to the accompanying figures in which:

FIG. 1A is a rear perspective view of a cargo bicycle according to an embodiment.

FIG. 1B is a front perspective view of a rear loading device of the cargo bicycle, according to an embodiment.

FIG. 2A is a front view of the rear loading device of FIG. 1B, according to an embodiment, in a fully deployed configuration.

FIG. 2B is a front view of the rear loading device of FIG. 2B, in a fully retracted configuration.

FIG. 2C is a rear perspective view of the rear loading device of FIGS. 2A-2B, showing additional components thereof.

FIG. 3 is a front view of a rear loading device, according to another embodiment.

FIG. 4 is a front perspective view of a rear loading device, according to another embodiment.

FIG. 5 is a front perspective view of a rear loading device, according to another embodiment.

FIG. 6 is a front perspective view of a rear loading device, according to another embodiment.

FIG. 7 is a partial front perspective view of a rear loading device, according to another embodiment.

FIG. 8A is a front perspective view of a steerable front fork and headtube of the cargo bicycle of FIG. 1A, with a reach and stack adjustment mechanism, according to an embodiment.

FIG. 8B is a side elevation view of the steerable front fork and headtube of FIG. 8A, shown in one configuration.

FIG. 8C is a side elevation view of the steerable front fork and headtube of FIG. 8A, shown in another configuration.

FIG. 8D is a magnified side elevation view of the reach and stack adjustment mechanism of the steerable front fork and headtube of FIG. 8A, with two local sectional areas.

FIG. 9A is a front perspective view of another exemplary reach and stack adjustment mechanism for bicycle adjustable mast or stem, mounted to a bicycle's fork and headtube.

FIG. 9B is a magnified side elevation view of the reach and stack adjustment mechanism of FIG. 9A, shown in two different angular configurations.

FIG. 10 is a front perspective view of another exemplary reach and stack adjustment mechanism for bicycle adjustable mast or stem, mounted to a bicycle's fork and headtube.

FIG. 11 is a front perspective view of exemplary reach and stack adjustment mechanism for bicycle adjustable mast or stem, mounted to a bicycle's fork and headtube.

FIG. 12 is a rear perspective view of a preset seat post height adjustment system of the cargo bicycle, according to an embodiment.

FIG. 13 is a magnified view of a component of the preset seat post height adjustment system of FIG. 12, mounted under a saddle, according to an embodiment.

FIG. 14 illustrates an elongated member of the preset seat post height adjustment system of FIG. 12, according to an embodiment.

FIGS. 15A-15B are perspective views in different angles, of components of the preset seat post height adjustment system of FIG. 12 mounted to the seat post.

FIGS. 16A-16B are perspective views of a stopper of the preset seat post height adjustment system of FIG. 12, according to an embodiment.

FIG. 17 is a perspective view of the preset seat post height adjustment system of FIG. 12.

FIG. 18 is an alternate embodiment of the preset seat post height adjustment system of FIG. 12.

FIGS. 19A-19B are rear perspective views of the cargo bicycle of FIG. 1A, with a side light stick mounted thereto, according to an embodiment.

FIGS. 20-21 are perspective views of exemplary couplings for mounting a side light stick such as in FIGS. 19A-19B to the cargo bicycle, according to various embodiments.

FIG. 22 is a rear perspective view of a cargo bicycle as in FIG. 1A, with an exemplary side light stick mounted thereto, according to an embodiment.

FIG. 23 is a rear perspective view of the cargo bicycle of FIG. 1A, with a rear end of its rear loading device opened to provide access.

FIG. 24 is a rear view of the cargo bicycle of FIG. 1A, with the rear end of its rear loading device closed.

FIG. 25 is a side elevation view of the rear loading device of the cargo bicycle of FIG. 1A.

### DETAILED DESCRIPTION

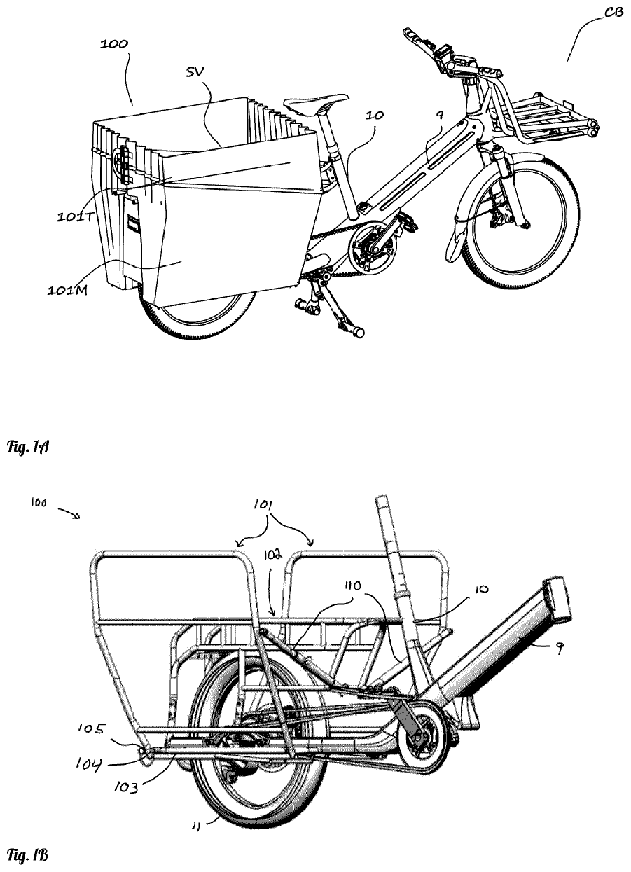

The present disclosure relates to cargo bicycles used to carry merchandise and/or passengers. The expression “cargo bicycle” is used herein, but other expressions could be used to describe the cargo bicycle, such as cargo bike, bike, bicycle, etc. FIG. 1A illustrates a cargo bicycle CB according to an embodiment. The cargo bicycle CB is adapted to carry merchandise, loads and/or passengers within an elongated rear loading structure configuration, typically referred to as longtail cargo bicycle CB.

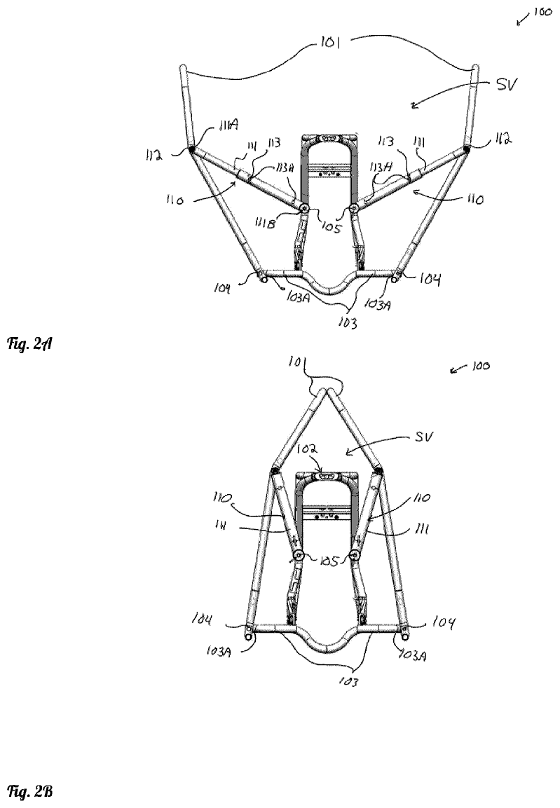

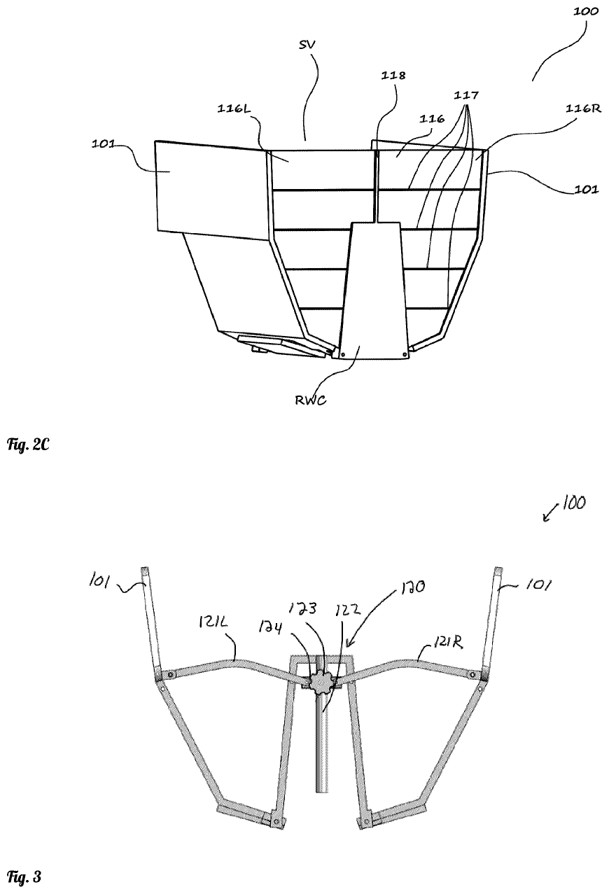

Referring to FIG. 1B and FIGS. 2A to 2C, a rear loading device 100 that is collapsible from a fully deployed configuration to a fully retracted configuration (or storage configuration) is generally shown in FIG. 2B. The rear loading device 100 disclosed herein is adapted to offer a retractable, accessible, modulary and/or removable loading device to offer a vast loading capacity when needed and reduce clutter when not needed, with some of these features being optional (e.g., the rear loading device 100 may for example not be removable, or may not be retractable). In FIG. 1B, components of the rear loading device 100 are shown, mounted to an exemplary cargo bicycle frame 9.

The rear loading device 100 generally includes a left and right side structures 101 (hereinafter occasionally referred to as panels), and a center structure 102, mounted at the rear of the cargo bicycle frame 9, with a combination of fixed and pivot mountings, allowing the adoption of various configurations of use of the rear loading device 100. The left and right side structures 101 may be referred to as panels as they may be constituted of frame members to which panels are attached. For simplicity, reference is made herein to panels 101, though in some embodiments, the structures 101 may be without panels. For example, the rear loading device 100 may be sold without panels, for the panels to be sold separately and attached to rear loading device 100 at some later point. The left and right side structures 101 may be referred to as structure portions as well, or as frames, walls, etc. In the illustrated variant, the structures 101 may be defined by inverted U-shaped structures pivotally connected at their ends.

The left and right-side panels 101 are pivotally connected to side loaders 103 (i.e., linkages or links), which may be an integral part of the cargo bicycle frame 9, or part of the center structure 102. Connection of the left and right-side panels 101 may be a hinge, e.g., one or more hinges. In an embodiment, there are at least a pair of hinges 104 for connection of each respective left and right-side panels 101. The two hinges 104 may be located on each side of the side loaders 103, hinges 104 on each side being at a maximum distance along the length of the cargo bicycle CB from each other, ensuring the resumption of any play in the assembly, as one hinge positioning possibility.

All attachment points of the side panels 101 to the side loaders 103 and to the center structure 102 may optionally feature quick-operating fasteners in order to allow a quick removal of the side panels 101 and related hardware when needed (e.g., maintenance, non-use, etc.). In FIGS. 2A-2B, both side panels 101 may be removed by releasing both push-button quick release pins 105 at the center structure 102 and both ones at the hinges 104. These quick-operating fasteners may also be lever or turn operated, slide action, screws, knobs, security or spring-loaded pins, just to name a few.

The center structure 102 include tubular members forming parts of its structure. The center structure 102 is located behind the seat tube 10 of the cargo bicycle CB. The center structure 102 extends generally over the rear wheel 11 of the cargo bicycle CB. In FIG. 1B, only the tubular members of the center structure 102 are shown. The center structure 102 may include rigid or semi-rigid panels—or a combination thereof—fixed on its structure. The center structure 102 may fully enclose the rear wheel 11, with top and side panels covering top and sides of the rear wheel 11. In at least some embodiments, these panels mounted on the center structure 102 may enclose the rear wheel 11 and may be removable to provide an easy access to the wheel 11 and drive components of the bicycle CB during assembly and maintenance, for example.

The center structure 102 may include a variety of fastening points to offer the possibility of properly mounting child seats along with the needed security components, lateral bars, passenger seat, luggage or other accessories and equipment, as some examples. Hooks, loops, brackets, or other attachment components on the top portion of the center structure 102, or elsewhere, may be contemplated. The center structure 102, also referred to as a central structure portion, is located rearwardly of the crankset of the bicycle.

The center structure 102 includes the side loaders 103 integrated in its structure. These side loaders 103 are located at the base (portion of the center structure 102 that is the closest from the ground) of the center structure 102. The side loaders 103 are structural members that project laterally relative to the bike frame 9. The side loaders 103 extends in opposite direction, on opposite sides of the bike frame 9.

In at least some embodiments, the side loaders 103 are structural members with their length being equal as the center structure's length. They may be shorter or longer in other embodiments. In some examples, such side loaders 103 may define an abutment face 103A on which the side panels 101 may abut in the fully deployed configuration. The abutment face 103A may block angularly the side panels 101 when they are pivoted in their fully deployed configuration (FIG. 2A), and may hence serve as movement stoppers. Both side loaders 103 may be used as footrests for passengers or to distribute the merchandise weight located inside the rear loading device 100.

In the fully deployed configuration, both left and right telescoping tubular member assemblies 110 are in full extension, and may maintain the side panels 101 in their respective angular positions relative to the center structure 102. In other use cases, where one or both side panels 101 have been removed, the side loaders 103 can be used to support relatively flat merchandise such as tall boxes, boards or other items which would not properly fit in the presence of the side panels, for example.

The rear loading device 100 includes a left and right-side telescoping tubular member assembly 110. The telescoping tubular member assembly 110 may also be known as a telescoping cylinder, and may be a spring-loaded telescoping cylinder, for instance arranged to displace the side panels 101 to the deployed configuration. The assembly 110 includes two telescopic tubular members 111, but there could be more (e.g., three, four, five . . . ) coaxially aligned members 111. The members 111 may slide or otherwise move translationally one with respect to the other to contract or extend upon application of opposing forces at opposite ends. Each assembly 110 is coupled at one end 111A to a respective one of the side panel 101 and to the center structure 102 or bike frame 9 at the other end 111B. Pivot points 112 are defined at each end 111A coupled at a respective side panel 101, via a pivot pin, joint, sleeve, bearing, screw and nut, etc. The ends 111A may be removably coupled to the respective side panels 101, though they could be permanently connected to the side panels 101 in some cases. Similarly, the end 111B coupled to the center structure 102 or bike frame 9 may have a pivot, either defined by the quick-release pin 105, or separate joints. When the side panels 101 are removed, the assemblies 110 may remain attached to the respective side panels 101 at pivot points 112, and simply be disconnected from the center structure 102, by the quick-release pin 105 for example. Upon movement of the panels 101, or a selected one of the panels 101 relative to the center structure 102, the assembly 110 may contract or extend to allow this relative movement along the rotation motion of the side panels 101. The telescoping tubular members assembly 11 may include quick-release pins 113 to ensure blocking of the translational motion between the telescopic tubular members 111 engaged together. Selected positions between the two extremums-fully deployed and fully retracted configurations—may be achieved by a series of holes 113H along the telescopic tubular members 111, in which the quick-release pins 113 may be inserted to block the motion of the side panels 101 relative to the center structure 102. Other blocking mechanisms of the telescoping members 111 could achieve the same results. Blocking translation by a cam, screw, friction, pawl and ratchet or rack and pinion are a few examples. An electric drive controllable at the handlebar or at the rear loading device 100, for example, could also operate the telescoping members 111 and/or blocking mechanisms, for example.

As shown in FIG. 2A, side panels 101 are moved away from each other, on their hinges 104, laterally with respect to the center structure 102. The assemblies 110 are extended, and the quick-release pins 113 (or other blocking mechanism), if present, may block the length of the assemblies 110, whereby the side panels 101 are barred from further angular movement relative to the center structure 102. In the fully deployed configuration, a maximal storage volume SV is defined in the space between the side panels 101, to receive merchandise, or passengers, for example. The side panels 101 may serve as lateral protectors, or gates, to protect the merchandise or passengers against impact with foreign objects.

In the fully retracted position, as shown in FIG. 2B, the side panels 101 may come together as they each pivot at their respective hinges 104. The side panels 101 may contact each other at their upper ends, but this is optional. The assemblies 110 may contract as the side panels 101 move towards the center structure 102 to gain the fully retracted configuration. As shown, the storage volume SV between the side panels 101 is reduced, so is the overall footprint of the rear loading device 100. The upper ends of the panels 101 could be locked together, such as by a locking device (e.g., rigid lock, cable lock, etc.) to prevent deployment of the side panels 101. This is only one example of anti-theft feature that could be contemplated to lock the side panels in the retracted configuration.

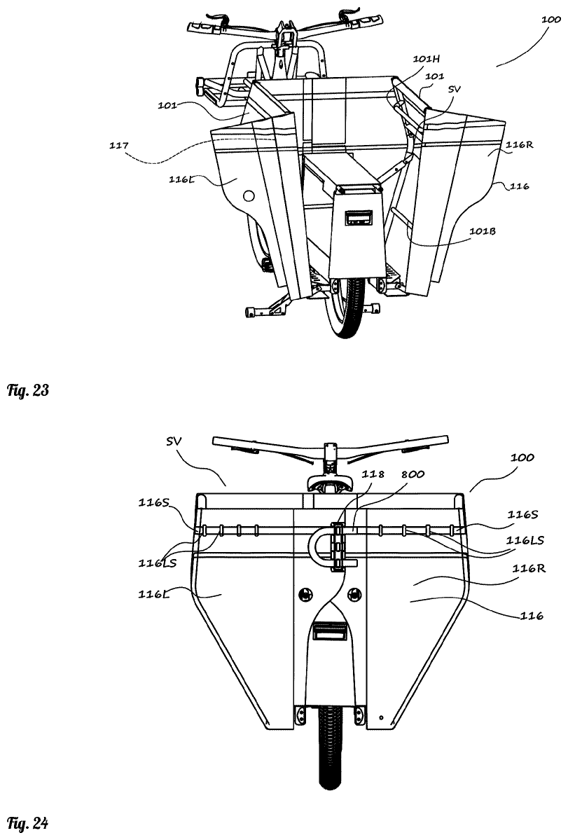

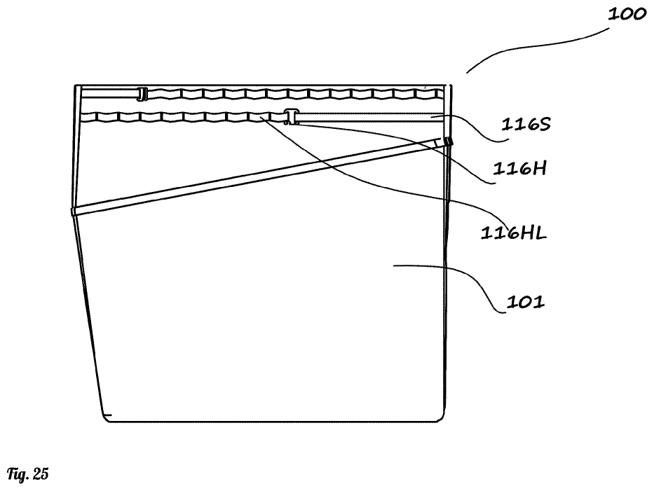

In order to obtain a collapsible enclosure with varying storage volume SV, and enclosing loading device in all configurations—in the fully deployed configuration and in the fully retracted configuration—as well as an easy cargo loading and entry point for passengers, the rear loading device 100 may have elasticized textile, flexible panels, or a plurality of rigid panels to form front and rear covers to the rear loading device 100. In embodiments where the panels include elasticized textile, the panels could include padding(s) (e.g., foam padding, or padding made of materials as used in protective wears in sports, such as in helmets, leg pads, etc.). As shown in FIG. 2C, an example of a rear cover 116 may include a left and right panels 116L, 116R, including elasticized textile, which may have embedded elastic cords 117 and fastening interface 118 that may be either formed around the edges of a rear wheel cover RWC (if present) and/or in a straight vertical line atop a center of rear wheel cover RWC. The fastening interface 118 which may link both left and right panels 116L, 116R of the rear cover 116 may include quick-release fixtures such as hook-and-loop fasteners, plastic buckles, magnetic strip/clips or zipper, as some examples. The rear cover 116 may fold in on itself in configurations that require the retraction of one or both side panels 101, independently or in unison. Additionally, in order to fully enclose cargo located in the storage volume SV the rear loading device 100, a similar single or multi, panel cover may be attached at a front of the device 100 along the side panels 101. Such front panel cover may conform to the outline of both side panels 101 to fully close a front end of the rear loading device 100. Additional details on flexible, textile panel arrangements are discussed herein later (FIGS. 23-24).

The side panels 101 may include a plurality of sections adapted to maximize cargo volume while preventing or limiting interference with the user when pedalling and/or the saddle during saddle height adjustment. In an embodiment, the side panels 101 may have a middle and a top sections 101M, 101T atop each other (either formed as a one integral, single piece with different sections or as separate parts attached together), as shown in FIG. 1A, shaped so as to limit interference with the pedalling volume and the saddle, respectively. At least the top section 101T of the side panels 101 may be formed in an angled back manner, parallel to the seat tube 10 of the bicycle frame 9, to allow an easy height adjustment of the rider saddle 10 without interfering with the panels, in at least some embodiments.

In a variant, illustrated in FIG. 3, the rear loading device 100 may have a rotation guiding mechanism 120, connected to the side panels 101 to control the opening/closing motion of the side panels 101 from the fully deployed to fully retracted configuration. The rotation guiding mechanism 120 includes a left and right link 121L, 121R, vertical tubular member 122 (e.g., tube), blocking handle 123 and sliding bracket 124. All these components are linked together to control the rotation of the side panels 101 on their respective hinges 104 and to be able to block the rotation in any position between the fully deployed configuration shown in as in FIG. 2A and the fully retracted configuration as shown in FIG. 2B. The blocking handle 123 is connected to the sliding bracket 124 and may interface the vertical tubular member 122 by either a male threaded shaft, spring-loaded pin or cylinder, rack and pinion, ratcheted arm mechanism or quick-release cam, as some possibilities. The left and right-side links 121L, 121R are both fixed on the sliding bracket 124 at one end and fixed on an inside face of the left and right-side panels 101 at their respective other end. Both fixtures on either ends of the links 121L, 121R are pivoting so as to allow rotation, thereby allowing the panels 101 rotation guiding mechanism 120 to move freely. By releasing the mechanism of the blocking handle 123 (e.g., unloading an interface between the vertical tubular member 122 and the sliding bracket 124), the sliding bracket 124, coaxially aligned with the vertical tubular member 122, may be free to move longitudinally along the vertical tubular member 122 in order to deploy or retract the rear loading device 100, by moving the side panels 101 towards and away each other in one angular degree of freedom. In an embodiment, both links 121L, 121R may have an upward curvature, as shown, in the center (or off-centered) of its length, for example, in order to accommodate and prevent interference with the user's heels motion in the pedaling volume of the bicycle frame 9. In a variant, the vertical tubular member 122 may be the seat tube 10.

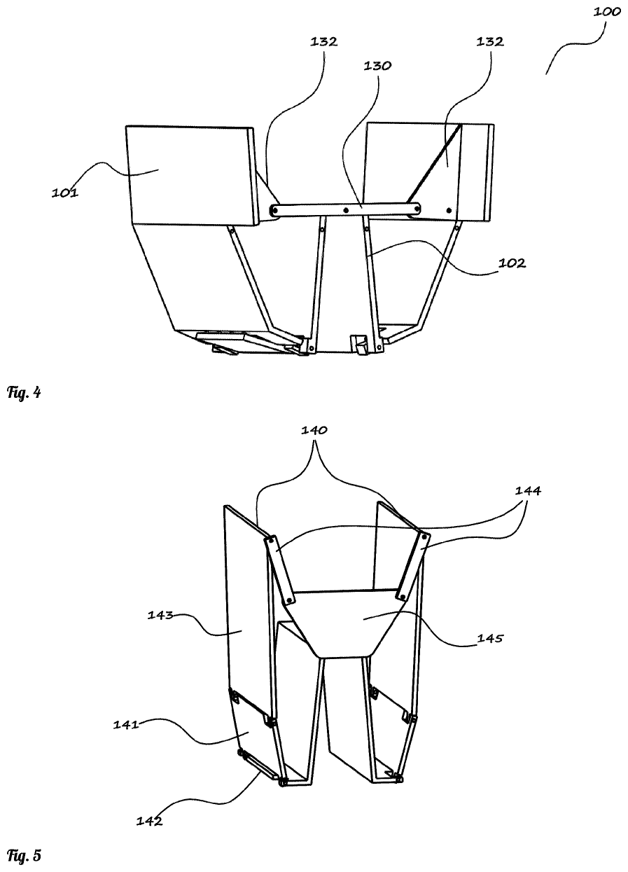

In another variant illustrated in FIG. 4, the different configurations of the rear loading device 100 may be fixed by a transversal bar 130 fixed to the center structure 102. As shown, both ends of the transversal bar 130 may have holes coaxially aligned with positioning holes located on each side panels triangular panels 132. In some examples, the transversal bar 130 ends may be aligned with first positioning holes on the side panel triangular section 132, as shown in FIG. 4, to benefit from the full width and maximized storage volume of the rear loading device 100. In another example, the positioning holes on the side panel triangular section 132 that are the closest from the inside face of the side panels 101 may be used to have a partially deployed configuration, where the fully deployed—larger volume—configuration of the rear loading device 100 is not needed. The transversal bar 130 may be completely removed and stored, hooked or fixed in a convenient location inside or outside the rear loading device 100 when not needed, for example when the rear loading device 100 is stored in its fully retracted configuration. The variant of FIG. 4 also has a sheet-like structure rather than a tubular structure as shown in FIGS. 2A-2C forming its panels, including side panels 101 and panels of the center structure 102.

In another variant shown in FIG. 5, the side panels 101 with fixed sections shown in the previous figures may be replaced by side panels 140 having at least two independent sections fixed together with a pivot joint, for instance. This variant may be considered as two pivots loading device, instead of a single pivot loading device. As shown, a lower section 141 of the left and right-side panels 140 is hinged on an horizontal panel 142 (horizontal or bottom panel, configured to mimic the side loaders discussed above with respect to other embodiments) at the base of the center structure 102. The side panels 140 have an upper section 143 hinged with suitable quick-release fixtures on the lower section 141. The upper section 143 and lower section 141 may define an articulated side panel. Both articulated side panels 140 may be moved independently from one another, guided by a member 144 fixed at one end to an extremity of the upper section 143 and at the other end to a center panel 145, here having a trapezoidal shape, attached to a front end of the center structure 102. Both ends of member 144 are pivotally connected. In order to allow fixed positions of both side panels 140, as described with respect to other embodiments above, both hinges located on each side panels may have a mechanism blocking rotation that can be easily manipulated to achieve full motion of all panels. In some examples, cam-lever, knob-grip, expanding diameter or spring loaded quick-release pins can be used to ensure proper rotation blocking in whichever configurations of the side panels, for example. One advantage of this variant of the rear loading device 100 is its reduced overall volume in a fully retracted configuration, which may be due to the presence of the articulated side panels 140 having an upper section 143 and a lower section 141 that are hingedly connected.

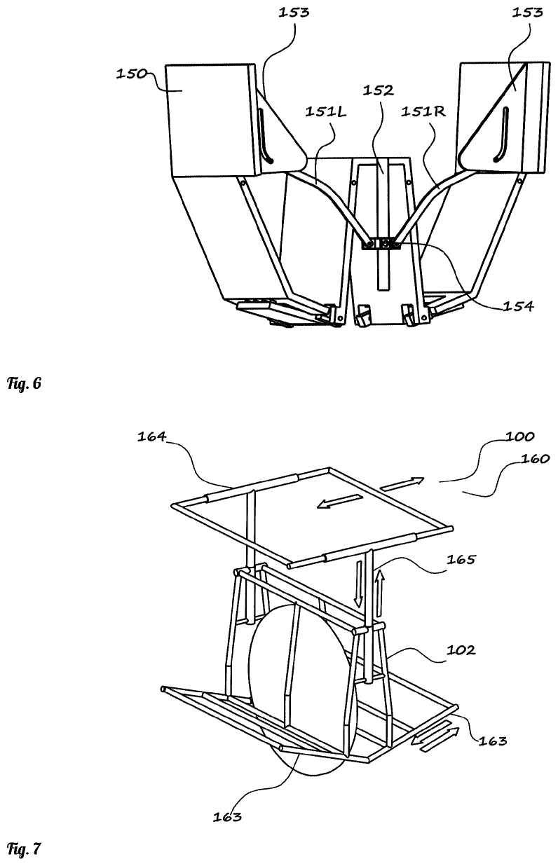

In another variant illustrated in FIG. 6, both side panels 150, left and right links 151L, 151R (which may be curved, as shown), vertical tube 152 and center structure 102 can be similar components as in FIG. 3. While the embodiment of FIG. 3 has a single action sliding mechanism that drives the side panels 101 in rotation about hinges at their base, this variant shows a dual action mechanism. Such a dual action mechanism may be utilized to drive both side panels 150 independently, allowing to operate one side panel at a time in order to configure the storage volume inside the rear loading device at a desired size. The motion of both side panels 150 may be guided by the left and right links 151L, 151R which may slide at one end in a curved trajectory defined by and in the triangular panels 153. This movement can be blocked at the desired position by a transversal bar as described earlier with respect to FIG. 4. The other end of left and right links 151L, 151R may be pivotally mounted on a fixture 154 mounted on the vertical tube 152. The fixture 154 may have a predetermined and fixed height along the length of the vertical tube 152, or an adjustable height as the embodiment shown in FIG. 3, with the appropriate sliding (or translational) connection between the fixture 154 and the vertical tube 152.

In another variant illustrated in FIG. 7, the rear loading device 100 includes an assembly 160 of tubing, which may be metallic, altogether forming the rear loading device 100. The assembly 160 includes a telescoping feature on a number of its tubing members in order to allow various configuration of cargo volumes. At least in this variant, the side panels, as described previously, may be replaced by flexible textile enfolding the side loaders extensions 163 of the center structure 102, and upper tubular members 164 in a way that the cargo placed in the loading device 100 may be always contained. The upper tubular members 164 may be connected to the center structure 102 by vertical tubular members 165, which may be coaxially aligned along their respective longitudinal axis and have a sliding tolerance fit which may allow a vertical motion of the upper structure relative to a lower structure (center structure 102), as marked with directional arrows in FIG. 7. Preferably, both side loaders extensions 163 and upper structure 164 forming the upper structure may feature the same telescoping function as mentioned above, with their motion direction shown in FIG. 7. Additionally, all tubular members having a telescoping feature may be blocked in their respective configuration by cam-lever quick-release or spring-loaded pins with predetermined positions, just to name a few examples, to fix the whole structure when in use. The assembly of FIG. 7 including the upper tubular members 164, side loaders extensions 163 and vertical tubular members 165, and any other members not integrated in the bicycle frame (FIG. 1B) may be removably mountable to the bicycle frame in order to allow minimal clutter, when not in use, while still featuring the ability to load merchandise and passengers, when desired. Such modularity of the rear loading device 100 may provide more versatility depending on the types of use of the cargo bicycle CB, and items to carry, or passengers to transport.

In order to ensure a proper rigidity to weight ratio, all components described herein may consist mainly of materials manufactured with methods such as bent metallic tubes which are mechanically welded, sheet metal manufacturing, composites manufacturing or others, just to name a few. In some examples, aluminum alloys of series 6000 and 7000 may be used for their great mechanical properties while being cost effective, light and durable.

The rear loading device described above in numerous variants may generally be described as having a central structure portion configured to be secured to a frame of the bicycle rearwardly of a crankset of the bicycle, a left-side structure portion and a right-side structure portion pivotally connected to the central structure portion, and a mechanism including at least one joint connecting the left-side structure portion and the right-side structure portion to the central structure portion or to the frame of the bicycle, the mechanism enabling displacement of the left-side structure portion and the right-side structure portion relative to one another between a deployed configuration in which top ends of the left-side structure portion and the right-side structure portion are distanced to define a cargo volume therebetween, and a retracted configuration in which the top ends of the left-side structure portion and the right-side structure portion are adjacent to one another to reduce the cargo volume. In a variant, the central structure portion surrounds a rear wheel of the bicycle, whereby a top portion of the central structure portion is configured to receive seating. In a variant, the mechanism may includes a left-side linear joint between the left-side structure portion and the central structure portion, and a right-side linear joint between the right-side structure portion and the central structure portion, an expansion of the left-side linear joint and of the right-side linear joint causing the displacement toward the deployed configuration. In another variant, the mechanism may include a single translational joint, and the single translation joint may be a bracket configured to slide along an upstanding frame member, with a left-side strut pivotally connected to the bracket and to the left-side structure portion, and with a right-side strut pivotally connected to the bracket and to the right-side structure portion. As a possibility, part of the central structure portion may be permanently connected to the frame of the bicycle.

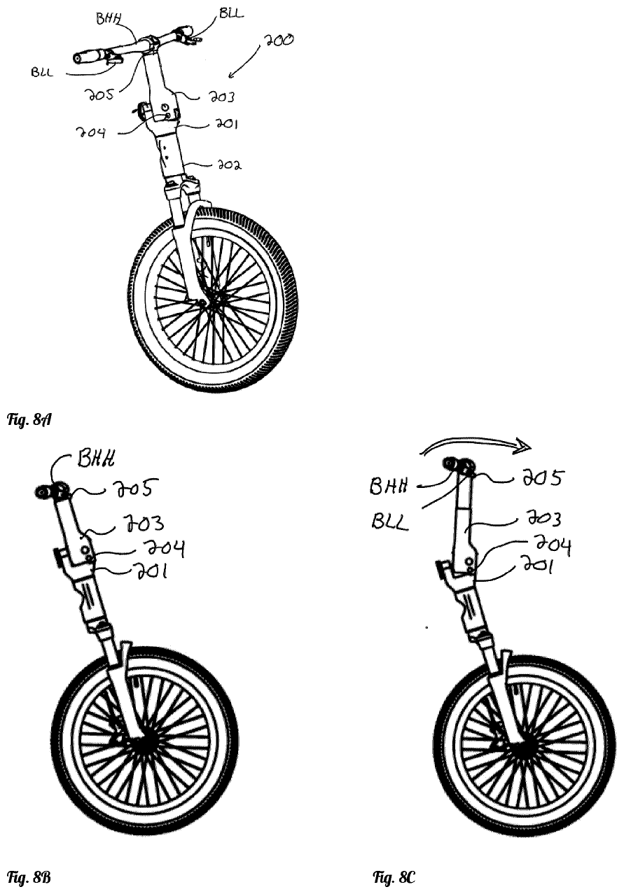

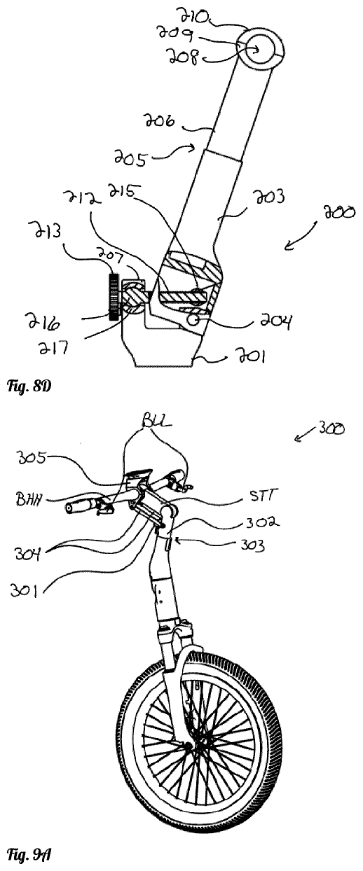

Other aspects of the cargo bicycle CB will now be described with reference to FIGS. 8 to 14, but such aspects may be used on bicycles that are not cargo bicycles. When sharing a cargo bicycle CB, handlebar position adjustment is highly desirable, especially if the different users have a big height difference. When adjusting the reach and stack of the bicycle one would want to keep a constant handlebar angle so that the brake levers, the shifters and any other handlebar mounted accessories keep the proper angle relative to the driver. Otherwise, the angle of the handlebar and attached levers, shifters and accessories can change radically from one position of the stem to the other. This can translate in an uncomfortable position or worst, the brake levers can be unreachable to the driver, which may cause security problems. It may become rapidly difficult and frustrating to adjust the handlebar position while keeping an ergonomic position of the handlebar, levers, shifters, etc., when tools are required to untighten, adjust, and tighten the components together while manually maintaining the settings and relative position of the components fixed during adjustment. In order to prevent or at least alleviate this, a reach and stack adjustment mechanism for bicycle adjustable mast or stem is disclosed herein, offering the ability to adjust the reach and stack of the bicycle without tools while keeping a constant handlebar angle.

An aim of this disclosure is to allow modifications to the reach and stack of the bicycle without tools. Another aim of this disclosure is to allow a constant handlebar angle or negligibly modified angle when adjusting the position of the handlebar (reach and stack of the bicycle). Another aim of this disclosure is, in some embodiments, to offer the possibility to retrofit a mechanism to an existing adjustable stem to make the adjustment easier by keeping the handlebar angle and side-to-side position constant while moving the handlebar and modifying the bicycle's reach and stack. Another aim of this disclosure is to improve the security of adjustable masts and stems by keeping the brake levers, the shifters and the other handlebar mounted accessories in a comfortable and easy to reach position for the driver throughout the range of adjustment of the mast and/or stem.

Referring to FIGS. 8A to 8D, a steerable front fork and headtube of the cargo bicycle CB of FIG. 1 is shown with a reach and stack adjustment mechanism assembly 200 (hereinafter assembly 200). The assembly includes a mast base 201 adapted to be coupled to the head of the steerer tube 202. The mast base 201 may be tightened to the steerer tube 202 in various ways, including bolts (e.g., Allen bolts) or any other equivalent hardware known to fix bicycle stems on steerer tubes. The head of the steerer tube 202 may be inserted in a cylindrical opening at a bottom of the mast base 201 and one or more bolts may tighten up the mast base 201 on the steerer tube 202. The assembly 200 includes a mast 203 which may be assembled to the mast base 201 with a pin 204 (FIG. 8D), which may be cylindrical, tubular or plain, for example. The pin 204 may be a dowel pin, a clevis pin, or other types of pins may also be contemplated. The pin 204 may define a pivot and be referred to as pivot pin 204. The mast 203 is pivotally connected to the mast base 201 via the pin 204. The pivot defined by the pin 204 may be a single pivot, either defined by a single pin 204 or separate pins or pin segments that may be coaxial. The mast 203 may pivot freely relative to the mast base 201 about the pin 204. The assembly 200 may include a telescopic stem 205 inserted coaxially into the mast 203. The stem could be of fixed length instead of having a telescopic feature, however telescopic stem 205 may provide more versatility and adjustability. The telescopic stem 205 position can be adjusted with a cam lever quick release, an arrangement of holes and clevis pin, a twist lock mechanism, a push button mechanism or any other equivalent mechanism to lock the telescopic stem 205 in place. The telescopic stem 205 has a cylindrical and/or sliding part 206, which may be keyed, D-shaped or have other shapes preventing rotation of the stem 205 relative to the mast 203. The mast 203 and the stem 205 may be rotatably fixed one with respect to the other while allowing telescopic adjustment to vary the overall length of the mast 203 and stem 205. A circular recess 208 is defined at an upper end 209 of the telescopic stem 205 by the stem 205 (or a separate part coupled to the upper end 209 of the stem 205) with a top cap 210 coupled to the upper end 209 of the stem 205. The circular recess 208 is adapted to receive the bicycle's handlebar BHH, which may be secured in place using screws or other fasteners—for example—on the stem 205.

As illustrated in FIGS. 8B-8C, rotation of the mast 203 relative to the mast base 201 about the pin 204 may translate into a forward or backward displacement of the handlebar BHH, providing the driver with some reach adjustability, Translation of the telescopic stem 205 into the mast 203 may provide a up and down displacement of the handlebar BHH, whereby stack adjustability may be obtained. Having the handlebar BHH at a distance from the pin 204—and thus pivot axis defined by the pin 204—may allow reach and stack adjustment with a minimal rotation of the brake levers BLL and other handlebar mounted accessories with respect to the driver. For a given angular adjustment—angled position of the mast 203 relative to the mast base 201 about the pin 104-a greater distance between the handlebar BHH and the pin 204 may provide a smaller angular position change of the handlebar BHH relative to the driver. In an embodiment, the distance between the pin 204 and the handlebar BHH is between 30% and 70% of the distance between the wheel axis and the handlebar BHH.

In FIG. 8D, components of the assembly 200 for controlling the angle of the mast 203 with respect to the mast base 201 are shown, with some viewed in a partial cross-section. The assembly 200 includes a threaded stud 212 which may be rotatably operated with a knob 213. Stud 212 may be referred to as a threaded stud knob. The knob 213 may be an integral part of stud 212. The threaded stud 212 may be engaged through the mast base 201. The stud 212 may extend perpendicularly with respect to the mast base 201, as shown. The stud 212 could be at angle—e.g., between 0 degree and 30 degrees—in other cases. The stud 212 extends along a stud axis. An end of the stud 212 may be engaged through a tapped hole 215 in the mast 203. The end of the stud 212 may be engaged to a pin inserted into the tapped hole 215 in some cases.

As shown, the threaded stud 212 may have a spherical collar 216 which may fit in a spherical groove 217 defined by the mast base 201 and/or a mast base cap 207. The spherical collar 216 may allow the stud 212 to rotate freely around is primary axis of rotation Z, the axis of the threads, while permitting small axial deviation on the X and Y axis. All the translations may be blocked. The threaded stud 212 may be threadingly engaged in the tapped hole 215 or engaged to the tapped hole 215 via a pin extending at the end of the stud 212. A rotation of the knob 213 may cause translation of the pin or stud 212 through the tapped hole 215 (or vice versa) which may then cause a rotation of the mast 203 about the pivot pin 204. Friction between the engaged parts may prevent or limit rotation of the knob 213 while riding the bicycle in at least some embodiments. However, in other embodiments, a second device may block the rotation of the knob 213 for security purposes. This may be obtained, for example, by having a rib or pin built into the knob's front facing surface (surface facing the mast base 201) received in a groove or pin hole defined in the mast base 201 and/or mast base cap 207, whereby rotation of the knob 213 may be locked. To rotate the knob 213, the user may need to pull the knob 213 away from the mast base 201 to disengage the rib/pin from the groove/pin hole. The knob 213 may be biased—such as via a spring load or other biasing mechanism—towards the locked position. Upon pulling the knob 213 out of engagement with the groove/pin hole, rotation may be effected. When the adjustment of the angle of the mast 203 is done, the knob 213 may return in its biased locked position to block rotation of the knob 213 and prevent rotation at undesired moments (e.g., during ride).

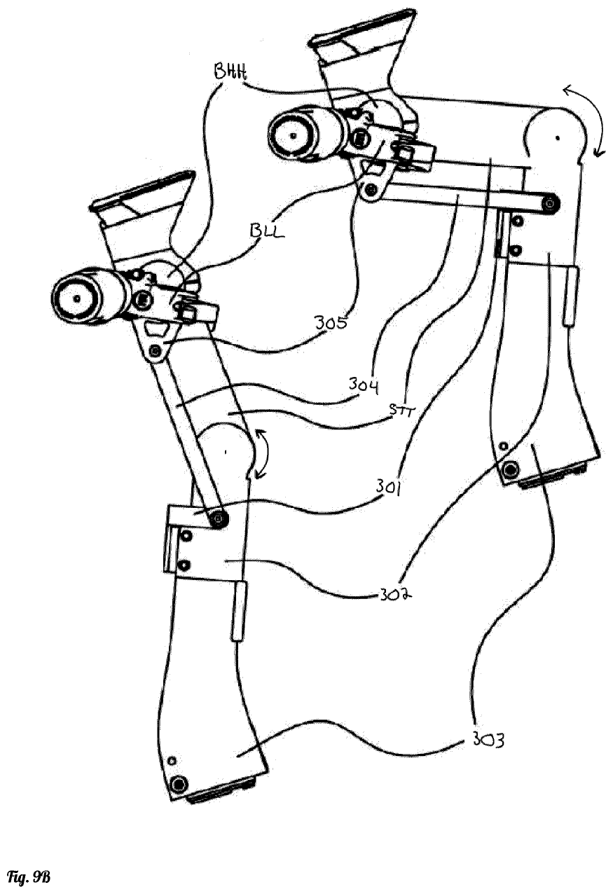

Referring to FIGS. 9A to 9B, another embodiment of the reach and stack adjustment mechanism 300 will now be described. The reach and stack adjustment mechanism 300 for bicycle adjustable mast or stem shown has a four bar configuration. The mechanism 300 is shown at FIG. 9B at two angular positions. The mechanism 300 includes a mounting bracket 301 attached to a component 302 of the mast 303 (or similar component). Parallel members 304 extend from the mounting bracket 301. Two parallel members 304 are shown, but there could be a single member 304 in other embodiments, or more than two (e.g., three, four . . . ). The mechanism 300 may be retrofitted to a off-the-shelf tool-free adjustable stem, such as the EZ3 or EZ-X stem commercialized by Satori.

These components may be manufactured using sheet metal, additive manufacturing, molding (e.g., injection molding) or other methods.

At least one parallel member 304 is attached to a stem base 302 through the mounting bracket 301 fixed on the existing stem base 302 with one or two of the bolts used for tightening the stem on the bicycle headtube, or by other fastening means. The parallel members 304 are assembled to the mounting bracket 301 with bolts and nuts, bolts and press-fit nuts or rivets, just to name a few examples. The parallel members 304 could also be fixed directly into the stem base 302, without any dedicated mounting bracket, by means of any hardware capable of accomplishing such task. A handlebar bracket 305 is fixed to the handlebar BHH so that no relative movement between these two components is possible. The handlebar bracket 305 could serve as a mounting point for a bicycle computer, a GPS unit, a phone or any other accessory, in at least some embodiments. The handlebar bracket 305 is coupled to the parallel members 304 at an end of the members 304 opposite that of mounting bracket 301. The coupling of the handlebar bracket 305 to the parallel members 304 may be made using the same technique as described above with respect to the mounting bracket 301 and parallel members 304. The parallel members 304 are of equal length as that of the stem STT, so as to maintain a proper ‘parallelogram type’ movement of the handlebar BHH throughout the existing stem's range of movement. The parallel members 304 are pivotally mounted at their ends to the stem base 302, at one end, and to the handlebar bracket 305 at their other ends. The stem STT is pivotally connected to the stem base 302, whereby rotation of the stem STT relative to the stem base 302 may be effected. As the stem STT rotates relative to the stem base 302, the parallel members 304 also rotate about their respective pivot axis on the stem base 302. The parallel members 304 and the stem STT may remain parallel one with respect to the others during rotation. During rotation, the handlebar bracket 305 may remain at a same angular position through the full range of motion from one position to the other position (FIG. 9B, showing a lowered configuration and a heightened configuration of the handlebar). A distance between a central axis of the handlebar BHH and a pivot axis of the parallel members 304 and the handlebar bracket 305 may be constant over the entire range of motion of the mechanism. Such distance may be the same as a distance between the rotation axis of the stem STT relative to the stem base 302, and the pivot axis of the parallel members 304 relative to the stem base 302. The handlebar BHH remains rotationally fixed relative to the handlebar bracket 305, as the mechanism 300 moves during height adjustment. Because of the four bar configuration, only one degree of freedom of movement is possible, about the stem axis of rotation, which in turn cause the height adjustment of the handlebar BHH. The reach and stack adjustment mechanism 300 may be locked in the desired position once the user has adjusted the reach and stack of the handlebar BHH. A locking mechanism, which may include a lever, cams, interlocking indentations, tensioner, etc., such as those of the tool-free adjustable stem commercialized by Satori, may be operated so as to block rotation of the stem STT relative to the stem base 302. Blocking this degree of freedom of movement at the stem STT may block movement of the whole mechanism 300 in place. When released, the locking mechanism may allow relative movement between the stem STT and the stem base 302, and movement of the mechanism 300 to adjust the height of the handlebar BHH. Such a locking mechanism could be part of the stem STT or part of the stem base 302, for example. The locking mechanism could allow tool-free locking and unlocking in at least some embodiments, so as to facilitate manipulation of the mechanism 300 and adjustment of the handlebar BHH. It may be said that the handlebar BHH has a constant orientation relative to the frame of the bike, while its position may vary.

In an embodiment, the locking mechanism may include a knob, as knob 213 and related features discussed above. The knob may be mounted at the stem rotation axis to manually turn the stem about its rotation axis. Friction between the engaged parts may prevent or limit rotation of the knob while riding the bicycle in at least some embodiments. However, in at least some other embodiments, a second device may block the rotation of the knob for security purposes. This may be obtained, for example, by having a release mechanism, which may include a rib or pin built into the knob's front facing surface (surface facing the stem) received in a groove or pin hole defined in the stem and/or mast, whereby rotation of the knob may be locked. To rotate the knob, the user may need to pull the knob away to disengage the rib/pin from the groove/pin hole. The knob may be biased—such as via a spring load or other biasing mechanism—towards the locked position. Upon pulling the knob out of engagement with the groove/pin hole, rotation may be effected. When the adjustment of the angle of the stem STT, the knob may return in its biased locked position to block rotation of the knob and thus prevent further movement of the mechanism 300.

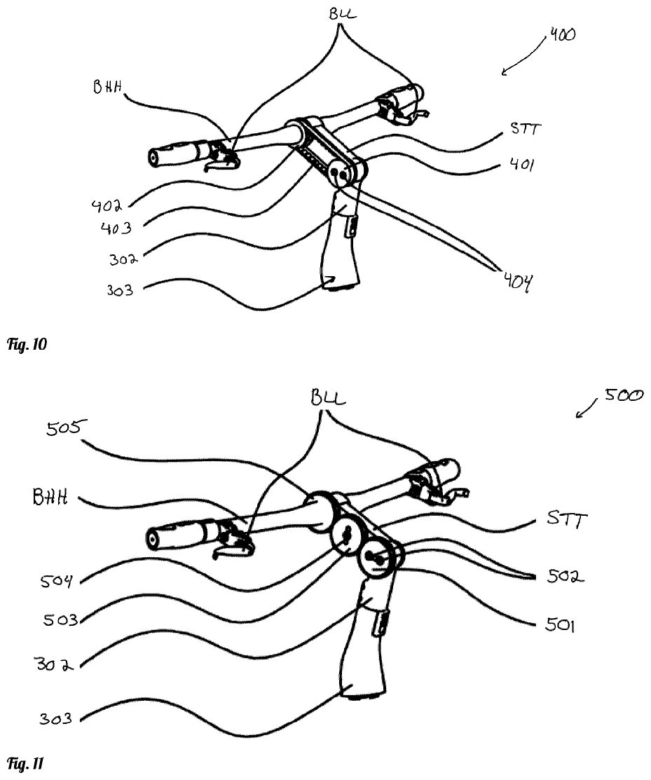

FIG. 10 illustrates another embodiment of the reach and stack adjustment mechanism. The mechanism 400 includes a pulley and belt assembly including two pulleys 401, 402, which may be of same diameter, and a belt 403, which may be a crenelated belt engaged to the pulleys 401, 402. One of the pulleys is a stem pulley 401 mounted at the stem rotation axis. The stem pulley 401 is fixed to the existing stem base 302 coaxially to its axis of rotation by means of two bolts 404 (at least one) or any other equivalent hardware. The handlebar pulley 402 is fixed to the handlebar BHH with a press fit, a set screw or any other equivalent method ensuring no relative movement between the pulley 402 and the handlebar BHH. The belt 403 engages these two pulleys 401, 402 together. The crenellations on the belt 403 may engage corresponding features of the pulleys 401, 402 so as to have reciprocal movement between the pulleys 401, 402 and belt 403. As the stem STT rotates about its rotation axis relative to the stem base 302, the handlebar BHH may rotate relative to the stem STT by operation of the pulleys 401, 402 and belt 403, by the same increments as the angular motion of the stem STT (where pulleys 401, 402 have the same diameter) so as to maintain the angular position of the handlebar BHH as the stem STT rotates to elevate or lower down the handlebar BHH, thereby maintaining the angle of the handlebar BHH relative to the rider constant throughout the range of movement of the adjustable stem STT. In this alternative of the reach and stack adjustment mechanism 400, movement of the stem SST after height adjustment is effected can be blocked, as discussed above with respect to mechanism 300. A locking mechanism may be operated so as to block rotation of the stem STT relative to the stem base 302. Blocking this degree of freedom of movement at the stem STT may block the whole mechanism 400 in place. Such a locking mechanism may include features such as those described above with reference to FIG. 9A-9B, to block rotation of the pulleys 401, 402 when the desired position of the handlebar BHH is obtained. The mechanism 400 may also be retrofitted to a tool-free adjustable stem such as those commercialized by Satori, as described above.

FIG. 11 illustrates another embodiment of the reach and stack adjustment mechanism. The mechanism includes an assembly 500 of three gears 501, 503, 505. One of the gear is a stem gear 501, named as such considering its mounting location. The stem gear 501 is fixed to the stem base 302 coaxially to its axis of rotation by means of two bolts 502 or any other equivalent hardware. The handlebar gear 505, named as such because of its mounting location, is fixed to the handlebar BHH with a press fit, a set screw or any other equivalent method ensuring no relative movement between the gear 505 and the handlebar BHH. A third gear, the linking gear 503, is fixed on the stem STT with a single bolt 504 or any other equivalent hardware ensuring that the gear can only rotate around its axis of rotation. This third gear 503 connects the two other gears 501, 505 together thereby providing reciprocal movement between the stem gear 901 and the handlebar gear 505. As the stem STT rotates about its rotation axis relative to the stem base 302, the linking gear 503 is driven by the fixed stem gear 501. The linking gear 503 correspondingly drive the handlebar gear 505 so as to rotate the handlebar BHH incrementally as the stem STT rotates. Rotation of the handlebar BHH as the stem STT rotates may maintain the angle of the handlebar BHH relative to the rider constant throughout the range of movement of the adjustable stem STT. Once the desired position of the handlebar BHH is obtained, the mechanism 500 may be locked in place with suitable locking mechanism, as described above with respect to other embodiments of mechanism 300, 400.

Other aspects of the cargo bicycle CB will now be described with reference to FIGS. 12 to 18. Dropper posts are commonly found on mountain bikes but their remote-controlled height adjustments can be useful for other categories of bicycles as well. For example, the cargo bicycle CB disclosed herein may include a dropper post as commonly found on mountain bikes. This may be particularly advantageous for cargo bicycle CBs that are one size fits all and/or meant to be shared and used by members of the family or by a number of users using the cargo bicycle CB for commercial use (e.g., transporting packages, transport mean in large facilities, short distance deliveries, etc.). Such dropper posts may be advantageous for a number of reasons: tool-less saddle height adjustability to suit all sizes of riders, theft-protection (a dropper post combined with common theft protected seat post collars is a great tool-less adjustable saddle height system that may protect from theft (or at least render theft less easy)), safety by on the fly adjustments (possibility to adjust the saddle height on a cargo bicycle CB while riding, if you get to a stop sign or traffic light and need to stop and put both feet on the ground for more stability, or if you ride on soft and/or loose surfaces, for example). One drawback of conventional dropper posts is that they are designed to be used by a single person such that a rider sets the maximum height to his/her proper riding height so that whenever he/she pushes on the remote control after dropping the saddle, the post pops right up to the good height. If the bike is shared by people of different heights, this will only be true for the tallest rider, the other riders will need to stop the post at an intermediate position which may be generally inconvenient to the point of stopping to use the dropping feature and just leaving the height fixed. The cargo bicycle CB disclosed herein may include a leash system 800 for the post that can be fitted with one or a plurality of stoppers to restrict the total travel length of the dropper post at desired and predetermined heights. The leash system 800 disclosed herein may be retrofitted to non-cargo bicycle CBs, or any other bicycles having conventional dropper posts.

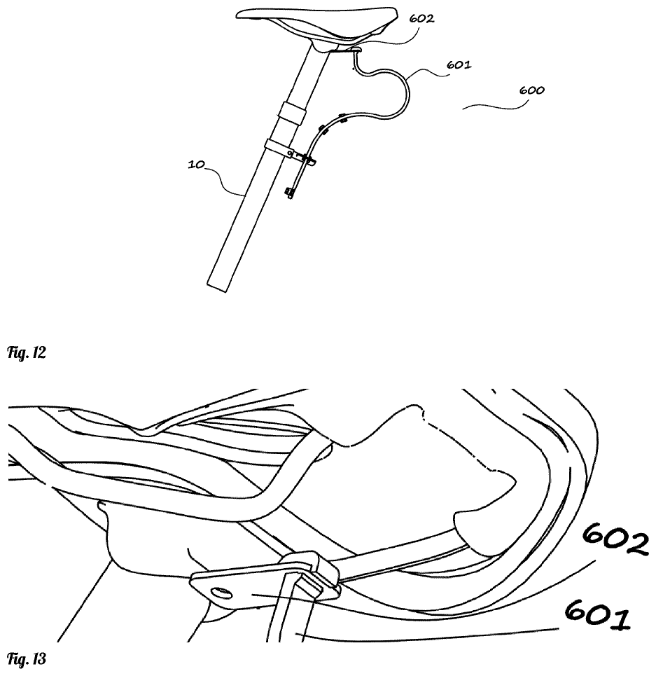

Referring to FIGS. 12-13, the leash system 600 includes a leash 601 attachable to the saddle structure (e.g., seat rails) or a fixed component of the seat post, such as seat rail coupling at the end of the seat post. In the embodiment shown, the system 600 includes a bracket 602 mountable to the seat rail coupling. The bracket 602 may be secured to the seat rail coupling in various ways, including by using bolts, screws or other fastening means and anchor points present on the seat rail coupling. The bracket 602 could be secured to the saddle rails in other embodiments, with fasteners and geometry adapted therefor. The bracket 602 could have different geometries and shape in other embodiments, for instance to contact or fit about the seat post and further limit movement therebetween, e.g., in addition to the fastener(s) discussed above. In the embodiment shown, an end of the leash 601 has interlocking features to lock into the bracket 602. The leash 601 could be secured to the bracket 602 in other ways, such as by fasteners.

As shown in FIG. 14, an arrangement of ribs or crenellations is molded in the leash 601. These features are adapted to engage with stoppers that can be clamped, or lock onto the leash 601 at desired locations along the length of the leash 601. These protruding features 601C are defined on opposite sides 601A, 601B of the leash 601 in the embodiment shown, but could be defined only on a single side (e.g., only one series of crenellation along the leash 601). The leash 601 may be flexible (little to no resistance to buckling), not to interfere with the movement of the dropper post as it elevates or lowers down. The leash 601 may be 3D printed, for example in TPU, or molded (elastomer, urethane, rubber), for example. The leash 601 may have an arc or elliptical shape, in an unloaded, non deformed state. The leash 601 may be rigid (not easily bendable), such that the leash 601 may be a rigid rod in some cases. The leash 601 may have a generally rectangular cross-section (albeit for the crenellations), but other cross-sections may be contemplated. The general shape of the leash 601 may be such that the leash will extend and retract with saddle movement and always move in a center plane of the bicycle (i.e., not sideways) to prevent/limit interferences with the user when pedalling.

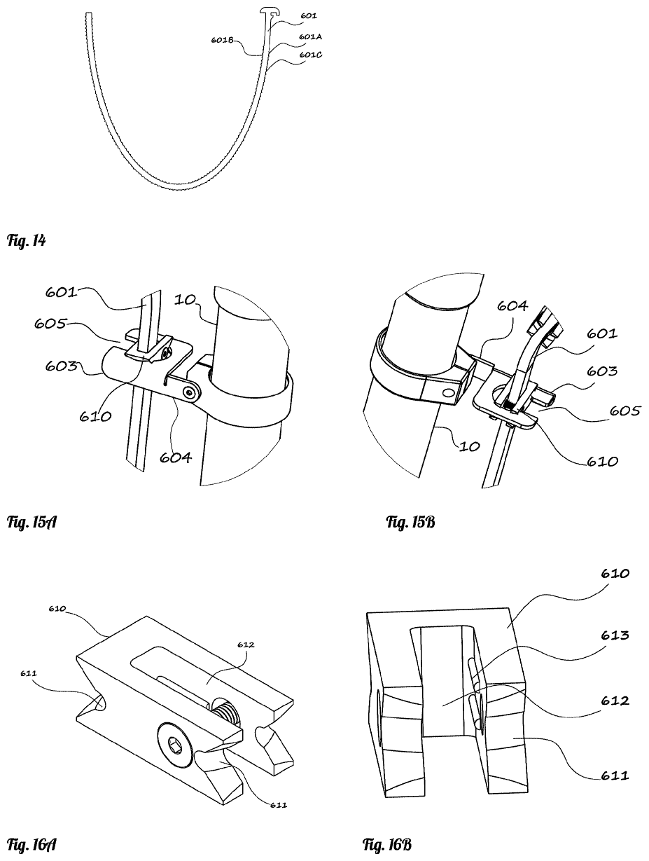

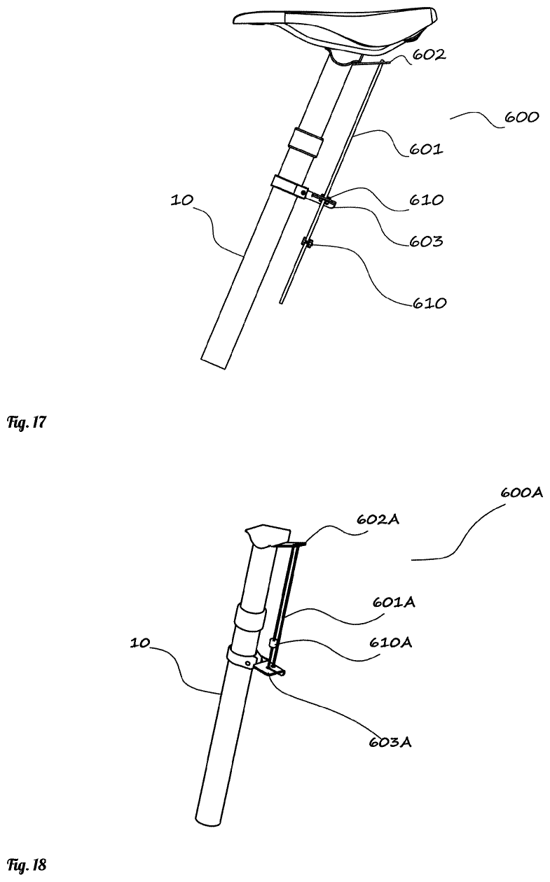

FIGS. 15A-15B show a seat collar attachment bracket 603 of the system 600. The seat collar attachment bracket 603 may be secured to the seat collar using the generic fastening means of the extendable seat post. If the bicycle to be equipped with the system 600 has a non-standard seat collar, a different attachment for the seat collar attachment bracket 603 could be contemplated to wrap around and/or be secured to the seat tube, either as an integral part of the bracket 603 or a separate part on which the bracket 903 may be secured. The bracket 603 may extend rearwardly relative to the seat post. The bracket 603 includes a collar attached portion 604 that may be screwed or otherwise fastened to the seat collar. The bracket 603 has a leash engagement part 605 here including a groove adapted to receive the leash 601 and engage features of a stopper secured to the leash 601. The leash engagement part 605 has a groove opening extending from a side of the bracket 603 and through which the leash 601 may be inserted. Edges of the groove may engage with sides of stopper 610, which is shown in isolation in FIG. 16A. As shown in FIG. 16A, the stopper has notches 611 defined at opposite sides thereof. These notches 611 are adapted to engage the edges of the groove of the seat collar attachment bracket 603. The stopper 610 also has a leash groove 612 through which the leash 601 may extend. The stopper 610 may be clamped onto the leash 601. The stopper 910 may have features 613 in the leash groove 612 that generally correspond and/or may engage with the crenellations of the leash 601. This is shown in FIG. 16B, for example. This may provide a sturdier connection of the stopper 610 on the leash 601. In an embodiment, the stopper 610 has a fastener that, upon tightening, may reduce the leash groove width so as to exert a clamping force on the leash 601. Other means may provide such clamping force, such as stopper deformation (e.g., stopper sized to required deformation to clamp onto the leash 601). Adhesive or other ways to secure the stopper 610 on the leash may be contemplated, with or without exerting a clamping force but still securing the stopper 610 in place. When the stopper 610 is tightened on the leash 601, the stopper 610 may be locked in place. Multiple stoppers 610 may be mounted on the leash 601, at desired location that may correspond to a desired seat post height position for a user.

Returning to FIGS. 15A-15B, once the leash 601 is secured to the bracket 602 and one or more stoppers 610 are secured on the leash 601, the leash 601 may be twisted so as to orient the slender side of the stopper 610 with the groove of the leash engagement part 605. The stopper 610 may then be slipped in the leash engagement part 605 and twisted so as to forcedly engage the notches 611 of the stopper 910 with the edges of the groove of the leash engagement part 605. This is illustrated in FIGS. 15A-15B. The stopper 610, and the leash 601, may thus remain captive in the leash engagement part 605. Friction between the stopper 610 and the edges of the groove may create a positive locking of these components together, although mechanical engagement between these components, without friction, could also suffice to lock the stopper 610 in place.

FIG. 17 shows the system 600 assembled on a seat post 10 of the cargo bicycle CB. The leash 601 is extended and secured at one end at the bracket 602 on the seat rail coupling. One of the stopper 610 is captive in the seat collar attachment bracket 603. In embodiments where the seat post 10 is a dropper seat post, the dropper seat post may be operated so as to pull the seat post out to lengthen the seat post. The seat post lengthening is limited by the leash 601 under tension, and stopper 610 captive in the bracket 603. The leash 601 and stopper 610 opposes to further lengthening of the seat post 10.

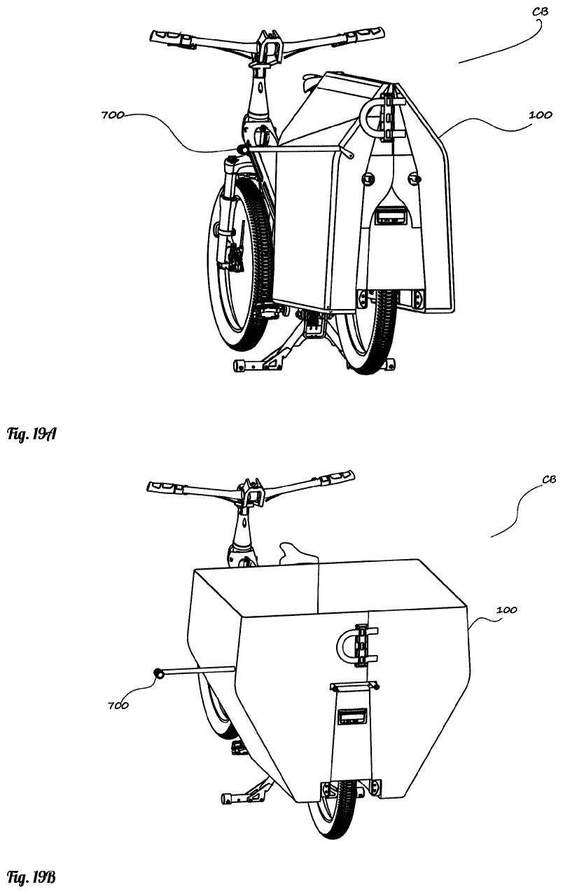

FIG. 18 illustrates an alternate embodiment of the leash system 600A. In FIG. 18, the leash 601 is, instead, one or more wire 601A extending from the bracket 602A (similar as bracket 602 described above). Stoppers 610A, in the form of beads securable to the wire, or crimps, may engage a bracket 603A (similar to bracket 603 described above). Beads remained captive in/with the bracket 603A may provide a similar result as the adjustable stoppers 610 discussed above captive in the bracket 603.

In at least some embodiments, the cargo bicycle CB may have safety devices. When riding a bicycle, close passes by a motor vehicle are common and can lead to crashes and injuries. The problem is exacerbated when transporting kids or any additional passenger on a cargo bike or in a bike trailer. The parent carrying his kids can become overly nervous, for good reason, when vehicles pass too close and have even more difficulties controlling his own vehicle. Side-projecting flags, mounted at the back of the bicycle exist and are sometimes coupled with retroreflective material. Their goal is to create an additional visible width to the bicycle viewed from the back, like one would observe driving towards the bicycle. The driver would then leave adequate room when passing, calculated from the distal end of the flag instead of from the narrower width of the bicycle rider silhouette. Nevertheless, this solution is sometimes not visible enough to be efficient when all other visual cues are centered on the bicycle (reflectors, lights, reflective clothing). Vehicles on the road usually have lights at their four most distal corners and not centered, this helps gauging their width.

Referring to FIGS. 19A-19B, a side light stick 700 is presented herein. The side light stick 700 includes lights e.g., light emitting diodes (LED). The side light stick 700 is side-mounted—reference relative to the cargo bicycle CB—so as to project laterally from the cargo bicycle CB. In at least some embodiments, the light stick 700 is the component of the cargo bicycle CB that projects the farthest laterally. The side light stick 700 may render the bicycle width more clearly visible to incoming traffic while allowing quick adjustments of the effective width of the stick 700 when the rider needs a narrower stance such as when riding on busy and narrow cycle paths or through dense pedestrian streets.

The side light stick 700 can be mounted on the rear loading device 100. It may then create a safe visual cue of the width of the cargo bicycle CB, knowing that the rear loading device 100 can be used at widths over 900 mm in some embodiments, which is much wider than a conventional bicycle. It can also be mounted on the rear rack, which may correspond to the center structure 102 discussed above, when the side panels of the rear loading device 100 are removed, or to other components of the cargo bicycle CB in other embodiments. For use on the cargo bicycle CB, or conventional bicycles and trailers, different attachment collars may be contemplated so as to adapt to different tube shapes. The mount and design of the light stick 700 may allow for easy flexion around the vertical axis and/or horizontal axis to softly yield if the stick 700 contacts a pedestrian, vehicle or any object. The whole stick 700 could be made of flexible material so as to allow resilience if impacted.

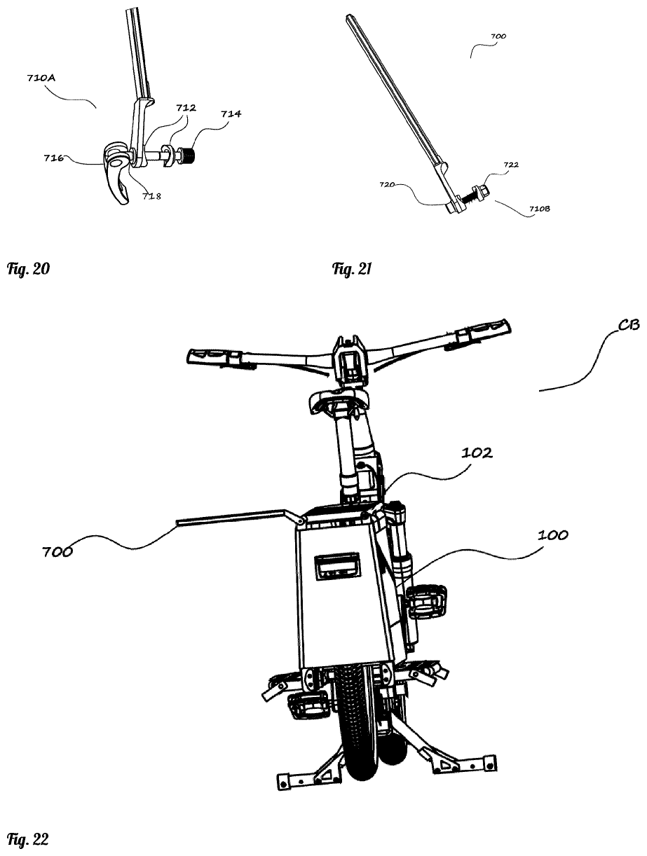

FIGS. 20-21 show exemplary couplings to mount an exemplary side light stick 700 onto a component of the cargo bicycle CB. The couplings 710A, 710B may allow for rotation in a vertical plane perpendicular to the longitudinal axis of the cargo bicycle CB and fixation in any of the intermediate positions from vertical to horizontal. This may be useful when mounted on the rear loading device 100 that can itself be adjusted wider or slimmer which changes the effective width and also the angle of the tubing to which the side light stick 700 may be attached.

In at least some embodiments, the side light stick 700 rotation is blocked or at least restrained by the friction resulting from the pressure exerted on the tubing by the washers 712 under compression by the screw 714, tensioned by a quick release lever 716 and a cam 718, as in FIG. 20. Similar pressure could be applied by the tension of a screw 720 and nut 722, as in FIG. 21, spring loaded washers or other equivalent methods. In some embodiments, a knob could be used to release the pressure when making adjustments to the rotation angle of the side light stick 700 and fix it in position. The washers may have a ribbed, knurled or serrated surface to provide higher friction, but this is optional.

FIG. 22 illustrates the side light stick 700 of FIGS. 20-21 mounted to the center structure 102 of a rear loading device 100 of the cargo bicycle CB. As shown, the side light stick 700 may be mounted onto the tubing (or other structural skeleton) of the rear loading device 100. The side light stick 700 may be mounted to one of the side, front or rear panels of the rear loading device 100, or extend through the panel and be mounted to the tubing, as some other possibilities. The side light stick 700 may be powered by its own internal rechargeable batteries, or wired to a dynamo on a wheel of the cargo bicycle CB or wired to the electrical bicycle battery, if present. If wired and when the side light stick 700 is removably coupled to the rear loading device 100, the wiring may include quick connectors. As shown in FIGS. 20-22, the side light stick 700 may include chip-on-board (COB) continuous LEDs along the full or a substantial portion (more than 75%) of the length of the side light stick 700. These can be colored red, white or amber depending on local regulations and/or if they face forward or backwards relative to the travel direction of the cargo bicycle CB. In other embodiments, one or multiple LEDs, enclosed in a metallic or plastic shell may be mounted at a distal end of the side light stick 700, as shown in FIGS. 19A-19B.

FIGS. 23-25 illustrate the rear loading device 100 as discussed hereinabove, with its rear cover 116 in an opened (FIG. 23) and closed (FIG. 24) configurations, whereby in the opened configuration, passengers may hop in the rear loading device 100 at the rear end of the rear loading device 100, and in the closed position, access to the storage volume of the rear loading device 100 is closed, for safety reason, for example. In the embodiment shown, the rear cover 116 includes a left panel 116L and a right panel 116R that are stretchable/elasticized so as to adapt to the retracted and deployed configurations of the rear loading device 100 and maintain the access to the storage volume SV through the rear end of the rear loading device 100 closed in either configurations. The left and right panels 116L, 116R of the rear cover 116 may fold on themselves when not stretched in the closed configuration. As shown, the left panel 116L and the right panel 116R may extend from respective side panels 101, which may also be textile and/or stretchable/elasticized panels. The left and right panels 116L, 116R of the rear cover 116 may be stitched or otherwise permanently attached to their respective side panels 101, or removably attached thereto, using hook-and-loop fasteners, clips (e.g., magnetic strip or clips), zippers, etc. The left and right panels 116L, 116R of the cover 116 may have elastic band(s), webbing, or cords 117 embedded therein or attached thereto, but this is optional. Such elastic components may oppose to stretching of the left and right panels 116L, 116R, so as to provide a tension in the left and right panels 116L, 116R when fastened together in the closed configuration, whereby stiffness of the textile panels may be obtained when stretched. In an embodiment, as shown, straps 116S extend transversely with respect to each panels 116L, 116R. The straps 116S may be associated with a respective one of the left and right panels 116L, 116R. The straps 116S may extend up to the fastening interface 118 and be attached thereto. As shown, the straps 116S may pass through a series of hoops 116LS (e.g., hoops, loops, eyelets) defined by or attached to the left and right panels 116L, 116R. As the rear loading device 100 is being deployed or retracted, the textile left and right panels 116L, 116R may fold over each other (see in FIG. 24 the forming of wrinkles in the respective one of the left and right panels 116L, 116R, when they are not fully extended in the fully deployed configuration of the rear loading device 100). The straps 116S may slide or otherwise move within the hoops 116LS. Once the rear loading device 100 is positioned in its desired deployed configuration, the straps 116S may be tightened so as to apply a tension on the left and right panels 116L, 116R, and strengthened them (remove the wrinkles). The straps 116S may be attached on the respective side panels 101, such as via a hook and hoop arrangement, clip, etc. Such hook and hoop arrangement is shown in FIG. 25. As shown, the side panels 101 may include one or more hoops 116HL to which a hook 116H, such as a G-hook, attached at an end of the strap 116S, may be attached. Tension in the strap 116S may be obtained manually, as the user pull on the strap 116S and attach the hook to the side panel 101 to maintain the tension and stretch the rear cover 116. The presence of numerous hoops 116HL may allow a user to select an appropriate one to have a suitable tension to keep the panels 116L, 116R taut.

In an embodiment, as shown, the fastening interface 118 which links both left and right rear panels 116L, 116R of the rear cover 116 in the closed configuration may include a magnetic latch mechanism 800, an example of which is a magnetic latch as those commercialized by Fidlock™.

While the rear cover 116 is described with openable left and right panels 116L, 116R, straps 116S and related features, and a closing mechanism, such as the magnetic latch mechanism 800, the features of the rear cover 116 described herein may apply similarly to a front panel cover of the rear loading device in some embodiments.

As an additional safety feature, in some embodiments, such as shown in FIG. 23, the tubular structure of the side panels 101 (e.g., of the inverted U-shaped member) may include an upper longitudinal member 101H extending along the length of one or both side panels 101 in the upper portion thereof. The upper longitudinal member 101H may serve as a handlebar for passengers. The upper longitudinal member 101H may extend inwardly offset from the textile panels (or outwardmost sheet like structure). A gap may be defined between the textile panels and the upper longitudinal member 101H to allow grabbing of the member 101H by passengers. This may prompt the passengers to grab the member 101H and keep their hands inside the storage volume SV during travel, for safety reason. The longitudinal member 101H may serve as a safety bar in the upper portion of the panels to allow additional protection for the passengers in case of lateral impact of the rear loading device 100 with foreign objects. A lower longitudinal member 101B may also extend along the length of one or both side panels 101 in the lower portion thereof. The lower longitudinal member 101B may extend at a height that is lower than the top of the center structure 102. The lower longitudinal member 101B may extend adjacent legs of the passengers (when present), to provide even more protection in this region of the panels 101. The lower longitudinal member 101B may serve as a support structure on which the textile panels may rest. The textile panels could also be attached to these members 101B, such as by hook-loop fasteners, clips or otherwise, to even better maintain the integrity of the side panel structure.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A rear loading device for a bicycle comprising:
a central structure portion configured to be secured to a frame of the bicycle rearwardly of a crankset of the bicycle,
a left-side structure portion and a right-side structure portion pivotally connected to the central structure portion, and
a mechanism including at least one joint connecting the left-side structure portion and the right-side structure portion to the central structure portion or to the frame of the bicycle, the mechanism enabling displacement of the left-side structure portion and the right-side structure portion relative to one another between a deployed configuration in which top ends of the left-side structure portion and the right-side structure portion are distanced to define a cargo volume therebetween, and a retracted configuration in which the top ends of the left-side structure portion and the right-side structure portion are adjacent to one another to reduce the cargo volume.

2. The rear loading device according to claim 1, wherein the central structure portion includes side loader links projecting laterally relative to the frame of the bicycle, the left-side structure portion and the right-side structure portion being pivotally connected to the side loader links.

3. The rear loading device according to claim 1, wherein the central structure portion surrounds a rear wheel of the bicycle, whereby a top portion of the central structure portion is configured to receive seating.

4. The rear loading device according to claim 1, wherein the mechanism includes a left-side linear joint between the left-side structure portion and the central structure portion, and a right-side linear joint between the right-side structure portion and the central structure portion, an expansion of the left-side linear joint and of the right-side linear joint causing the displacement toward the deployed configuration.

5. The rear loading device according to claim 4, wherein the left-side linear joint and the right-side linear joint are pivotally connected at opposed ends to the central structure portion, and to the left-side structure portion and to the right-side structure portion, respectively.

6. The rear loading device according to claim 4, wherein the left-side linear joint and the right-side linear joint are telescopic joints.

7. The rear loading device according to claim 6, wherein the telescopic joints are telescopic cylinders having lockable positions.

8. The rear loading device according to claim 7, wherein the telescopic cylinders are manually lockable to the lockable positions.

9. The rear loading device according to claim 4, wherein the left-side linear joint and the right-side linear joint are releasably connected to the central structure portion.

10. The rear loading device according to claim 1, wherein the mechanism includes a single translational joint.

11. The rear loading device according to claim 10, wherein the single translation joint is a bracket configured to slide along an upstanding frame member, with a left-side strut pivotally connected to the bracket and to the left-side structure portion, and with a right-side strut pivotally connected to the bracket and to the right-side structure portion.

12. The rear loading device according to claim 11, wherein the upstanding frame member is a seat tube of the frame of the bicycle.

13. The rear loading device according to claim 11, wherein a blocking handle is manipulable to lock the bracket along the upstanding frame member.

14. The rear loading device according to claim 1, wherein the left-side structure portion and the right-side structure portion are releasably connected to the central structure portion.

15. The rear loading device according to claim 1, wherein the left-side structure portion and the right-side structure portion include inverted U-shaped structures pivotally connected at the free ends to the central structure portion.

16. The rear loading device according to claim 1, wherein panels cover the U-shaped structures.

17. The rear loading device according to claim 15, wherein at least one rear panel extends from a rear portion of the left-side structure portion and the right-side structure portion.

18. The rear loading device according to claim 17, wherein the at least one rear panel has a closeable access.

19. The rear loading device according to claim 1, wherein at least part of the central structure portion is permanently connected to the frame of the bicycle.

20. A bicycle comprising:
a frame; and
the rear loading device in accordance with claim 1, the rear-loading device being mounted to the frame.
